(19) United States
(12) Patent Application Publication
(10) Pub. No.: US 2026/0336987 A1
(43) Pub. Date: Oct. 29, 2026

(54) STEERING ARRANGEMENT FOR A MOBILE WORKING MACHINE, AND MOBILE WORKING MACHINE HAVING SUCH A STEERING ARRANGEMENT

(71) Applicant: Liebherr-Werk Ehingen GmbH, Ehingen (DE)

(72) Inventors: Michael ENGST, Ehingen (DE); Nikolaus MÜNCH, Mehrstetten (DE)

(21) Appl. No.: 19/655,033

(22) Filed: Apr. 22, 2026

(30) Foreign Application Priority Data
Apr. 23, 2025 (DE) 10 2025 115 691.3

(51) Int. Cl. B66C 13/20; B60R 16/033; B62D 5/06; B62D 5/065; B62D 5/30; B66C 13/12

(52) U.S. Cl. CPC B66C 13/20; B60R 16/033; B62D 5/064; B62D 5/065; B62D 5/30; B66C 13/12

(57) ABSTRACT

The disclosure relates to a steering arrangement for a mobile working machine, in particular a crane, which comprises a steering cylinder for moving a steering rod in order to vary a steering angle of a wheel of the mobile working machine, a hydraulic steering pump for supplying a fluid to the steering cylinder, and a drive of the hydraulic steering pump. The arrangement is characterized by an energy storage device for storing electrical energy, wherein the drive of the hydraulic steering pump is an electric motor that can be driven with energy from the energy storage device.

### CROSS REFERENCE TO RELATED APPLICATION

The present application claims priority to German Patent Application No. 10 2025 115 691.3 filed on Apr. 23, 2025. The entire contents of the above-listed application are hereby incorporated by reference for all purposes.

### TECHNICAL FIELD

The present disclosure relates to a steering arrangement for a mobile working machine, for example a crane, and to a mobile working machine equipped with such a steering arrangement.

### BACKGROUND

Mobile working machines, for example cranes such as mobile cranes, are essential for construction, transport and assembly work and must at the same time be reliably and precisely controllable. The steering arrangement is a central component here since it substantially determines the direction of travel and thus also the positioning and maneuverability of the working machine. Reliable and precise steering is of great importance, particularly in confined space conditions on construction sites or in urban environments.

### SUMMARY

Steering arrangements according to the prior art, however, have disadvantages, since the hydraulic steering pumps are customarily driven mechanically directly by the internal combustion engine of the working machine, in that the pumps are connected to a shaft driven by the internal combustion engine. This is disadvantageous as far as the engine itself must be operated even when only a low hydraulic power for the steering is required, for example when steering at standstill or at very low travel speeds. This results in an unnecessarily high fuel consumption, associated with increased exhaust-gas and noise emissions, as well as the necessity of having to leave the engine running even when it is at an unfavorable operating point.

In addition, the direct mechanical coupling to the internal combustion engine entails a restricted placement of the steering pump and thus makes maintenance and assembly work more difficult. In the event of failure or standstill of the engine, the steering system is at the same time also no longer operated sufficiently or not at all, which negatively influences the functionality of the mobile working machine. The redundant system could be required.

Against this background, there is a need for a steering arrangement which avoids or at least mitigates these disadvantages and proposes a steering arrangement improved over the conventional steering arrangement. This is achieved with a steering arrangement as described herein, or with a mobile working machine having such a steering arrangement.

The steering arrangement according to the disclosure for a mobile working machine, for example a crane, comprises a steering cylinder for moving a steering rod in order to vary a steering angle of a wheel of the mobile working machine, a hydraulic steering pump for supplying a fluid to the steering cylinder, and a drive of the hydraulic steering pump. The steering arrangement is characterized in that it further has an energy storage device for storing electrical energy, wherein the drive of the hydraulic steering pump is an electric motor which can be driven with energy from the energy storage device.

The essential function of the steering arrangement consists in moving a steering rod by way of a hydraulic steering cylinder, whereby the steering angle of one or more wheels of the working machine can be precisely set and changed. For this purpose, a hydraulic fluid is delivered to the steering cylinder by a hydraulic steering pump.

The special feature of this disclosure lies in the fact that the drive of this hydraulic steering pump is not effected, as in the prior art to date, mechanically via the internal combustion engine of the machine, but instead an electric drive is provided. Specifically, this means that the hydraulic steering pump is driven by means of an electric motor, which in turn receives electrical energy from an energy storage device provided in particular specifically for this purpose.

The use of an electric drive of the steering pump offers several advantages. One of the central advantages consists in the possibility of operating the steering arrangement without emissions, for example at standstill or at low travel speeds, whereby operation of an internal combustion engine, e.g. a diesel engine, is eliminated, which previously also consumed energy at standstill and in the process caused exhaust-gas emissions as well as noise. In addition, operation of the internal combustion engine at standstill was also characterized by the fact that this took place at an unfavorable operating point for the engine, which was disadvantageous with regard to efficiency.

By virtue of the independence of the steering-pump drive from the travel drive, it is additionally achieved that an unrestricted steering function is maintained even when the travel drive is switched off or defective, which considerably increases the safety and the operational capability of the machine.

A further advantage results from the fact that the electric steering pump can be arranged flexibly in the vehicle and no longer has to be positioned necessarily in the immediate vicinity of the internal combustion engine, since engagement with a shaft driven by the internal combustion engine is now no longer required. The possibility of being able to arrange the components of the steering arrangement flexibly leads to an optimized weight distribution and contributes to better utilization of the available installation space within the mobile working machine.

According to an optional modification of the present disclosure, provision can be made for the steering arrangement further to comprise a direct-current intermediate circuit, via which the electric motor for driving the hydraulic steering pump and the energy storage device are connected to one another, optionally wherein an inverter is arranged between the electric motor and the direct-current intermediate circuit in order to convert the direct current into an alternating current for the electric motor.

The use of a direct-current intermediate circuit optimizes the energy supply of the electric motor by providing and distributing electrical energy efficiently. The inverter can additionally improve the operating efficiency of the electric motor by precise control and adaptation to the required operating state.

According to an optional modification of the present disclosure, provision can be made for the steering arrangement further to comprise a wheel-driven pump, which is designed to supply fluid to the steering cylinder as a function of a rotation of a wheel of the mobile working machine.

The wheel-driven pump ensures reliable redundancy and contributes to maintaining the steering function even in the event of malfunctions in the electrical system. This improves the operational safety and reliability of the steering function. The wheel-driven pump is thus driven simultaneously with a rotation of a wheel of the mobile working machine, so that during travel of the mobile working machine the wheel-driven pump can generate sufficient volumetric flow rate of the fluid in order to ensure steering. At low speeds or at standstill, the wheel-driven pump cannot provide sufficient fluid to support or carry out steering. Nevertheless, it is thereby prevented that a failure of the electric pump during travel simultaneously also leads to a failure of the steering of the mobile working machine.

Provision can optionally be made here for the steering arrangement to be designed, upon the exceeding of a predetermined volumetric-flow threshold value of the fluid of the wheel-driven pump, to stop the electric motor for driving the hydraulic steering pump in order to save energy, optionally wherein the volumetric-flow threshold value is a defined travel speed of the mobile working machine or is directly proportional to a travel speed of the mobile working machine.

By the automatic switching-off of the electric motor in the event of a sufficient fluid volumetric flow rate from the wheel-driven pump, unnecessary energy consumption is avoided. This reduces the energy requirement of the mobile working machine and saves operating costs.

According to a further optional development of the present disclosure, provision can be made for the steering arrangement further to comprise a generator unit, which serves to supply the energy storage device with energy.

The generator unit ensures a constant and reliable energy supply of the energy storage device. As a result, the operating duration increases and the need for external charging is reduced, which improves the availability of the machine.

Provision can optionally be made here for the generator unit to be connected to the direct-current intermediate circuit and accordingly also to be designed to supply electrical energy to the electric motor for driving the hydraulic steering pump.

The integration of the generator unit in the direct-current intermediate circuit ensures efficient energy distribution and enables the direct supply of the electric motor or of other components connected to the direct-current intermediate circuit. As a result, the overall efficiency of the system is increased and operating costs can be reduced.

According to a further advantageous development of the present disclosure, provision can be made for several hydraulic steering pumps to be provided, the respective drive of which takes place via the electric motor, and/or for the electric motor to be a liquid-cooled electric motor.

Several hydraulic steering pumps increase the failure safety of the steering system through redundancy. A liquid-cooled electric motor additionally offers the advantage of a lower space requirement and better thermal efficiency, which also increases the service life.

The disclosure further relates to a mobile working machine, for example a crane, which has a steering arrangement according to one of the previously discussed aspects and a travel drive for driving at least one wheel of the mobile working machine, wherein the travel drive comprises an electric motor and/or an internal combustion engine.

The combination of electric motor and/or internal combustion engine enables versatile application scenarios, from fully electric operation through to hybrid operation, which allows flexibility in use and optimum adaptation to the operating conditions.

As the mobile working machine, for example, a crane such as a mobile crane comes into consideration, which can have a multiplicity of steered axles, so that embodiments of a mobile crane with at least five axles, of which more than two, optionally even more than three axles, can be steered, are described.

Provision can optionally be made for the mobile working machine to have an undercarriage and a superstructure arranged rotatably relative thereto, and for the hydraulic steering pump and the electric motor for driving the hydraulic steering pump to be arranged in the undercarriage.

The placement of the steering pump and of the electric motor in the undercarriage improves the weight distribution and stability of the machine. This facilitates maintenance work and reduces the maintenance effort overall.

According to a further optional modification of the present disclosure, provision can be made for the mobile working machine further to comprise an electric fan for cooling the fluid, cooling water and/or charge air, an electric compressed-air compressor for providing compressed air in order to actuate a brake of the mobile working machine, an electric air-conditioning compressor for driving an air-conditioning unit in order to air-condition a driver’s cab of the mobile working machine, an electric heating element for heating the driver’s cab of the mobile working machine, and/or an electric crane pump for driving crane functions, optionally wherein the electric fan, the electric compressed-air compressor, the electric air-conditioning compressor, the electric heating element and/or the electric crane pump are connected to the direct-current intermediate circuit in order to draw their energy therefrom.

Electric auxiliary consumers enable emission-free and energy-efficient machine functions independently of the internal combustion engine. This saves fuel, reduces operating costs and increases operating comfort through constant performance capability.

According to a further advantageous development of the present disclosure, provision can be made that, when the travel drive comprises an internal combustion engine, the generator is installed on the internal combustion engine in order to generate directly, with the aid of the internal combustion engine, the energy required for operating the electric motor.

A generator installed directly on the internal combustion engine ensures an efficient and immediately available electrical energy supply, reduces system complexity and improves the overall efficiency of the machine.

Furthermore, according to an advantageous development of the present disclosure, provision can be made that, when the travel drive comprises an internal combustion engine, the generator is arranged on a shaft which is located after a shift transmission, that is to say rotates as a function of travel speed, in order to charge the energy storage device only during travel.

The arrangement of the generator on the shift transmission ensures efficient charging of the battery as a function of travel speed. At standstill, unnecessary generator operation is eliminated, which reduces fuel consumption and wear.

Provision can advantageously be made for the travel drive not to be a central travel drive, but an axle-related or wheel-related travel drive, which drives at least one axle or at least one wheel of the mobile working machine.

An axle-related or wheel-related travel drive reduces mechanical complexity and increases efficiency by eliminating loss-prone transmission elements and creating more free space for the design of the machine.

According to a further advantageous modification of the present disclosure, provision can be made for the hydraulic steering pump, the fan, the compressed-air compressor, the air-conditioning compressor, the heating element and/or the crane pump to be decoupled from a drivetrain of the mobile working machine.

The decoupling of the auxiliary consumers from the drivetrain allows their flexible positioning, optimizes the weight distribution and reduces losses through unnecessary mechanical transmissions, which increases the overall performance of the machine.

According to an optional development of the present disclosure, provision can be made for the hydraulic steering pump, the fan, the compressed-air compressor, the air-conditioning compressor, the heating element and/or the crane pump to be configured as high-voltage component(s).

High-voltage components enable compact, high-performance solutions with lower current intensities and thus less space requirement. This facilitates integration and maintenance and improves system efficiency.

Provision can furthermore be made for the hydraulic steering pump to be configured as a fixed-displacement pump, the volumetric flow rate of which can be adjusted by speed control of the electric motor.

The use of fixed-displacement pumps with a speed-variable electric motor reduces system costs, minimizes the installation-space requirement and increases efficiency compared with conventional flow-rate-controlled pumps.

According to an optional development of the present disclosure, provision can be made for the hydraulic steering pump additionally, by way of a hydraulic switchover, to be designed to supply cylinders of an outrigger system and/or of an axle suspension of the mobile working machine with fluid.

The hydraulic switchover allows versatile use of the hydraulic pumps, which reduces the number of required pumps, lowers costs and enables the emission-free provision of further functions.

Further, according to the present disclosure, provision can be made that, in a fully electric embodiment of the travel drive without a shift transmission, the electric motor of the travel drive can be operated in a direction of rotation that can in each case be reversed for forward travel and reverse travel, while the hydraulic steering pump can always be operated in the same direction of rotation independently of the direction of rotation of the electric motor.

The independence of direction of rotation of the electric travel drive reduces the mechanical effort, avoids additional transmissions and improves the efficiency and robustness of the overall system.

Provision can advantageously be made for the hydraulic steering pump to be operable independently of operation of the travel drive, so that the travel drive does not have to be operated, at standstill of the mobile working machine, in order to provide the volumetric flow rate required for a steering movement.

The independent operability of the steering pump from the travel drive considerably lowers fuel consumption, since the travel drive does not have to be operated at standstill, and at the same time increases system availability.

Provision can optionally be made for the electric motor for driving the hydraulic steering pump to be switchable off at higher travel speeds of the mobile working machine in order to save energy, while in this operating state the steering cylinder is supplied with fluid exclusively via the wheel-driven pump.

The possibility of switching off or stopping the electric motor at higher speeds saves energy, since the wheel-driven pump ensures sufficient fluid supply. This leads to more efficient operation and lower operating costs.

### BRIEF DESCRIPTION OF THE FIGURES

Further features, details and advantages of the disclosure are apparent from the exemplary embodiments explained below with reference to the figures. The Figures show in:

FIGS. 1A and 1B: a schematic illustration of a steering and drive arrangement according to the prior art,

FIG. 2: a schematic illustration of a steering and drive arrangement according to the disclosure,

FIG. 3: a schematic illustration of a steering and drive arrangement according to the disclosure according to a further embodiment,

FIG. 4: an illustration for visualizing the various possibilities for implementing the travel drive, and

FIG. 5: a schematic illustration of the components and connections of the high-voltage system.

### DETAILED DESCRIPTION

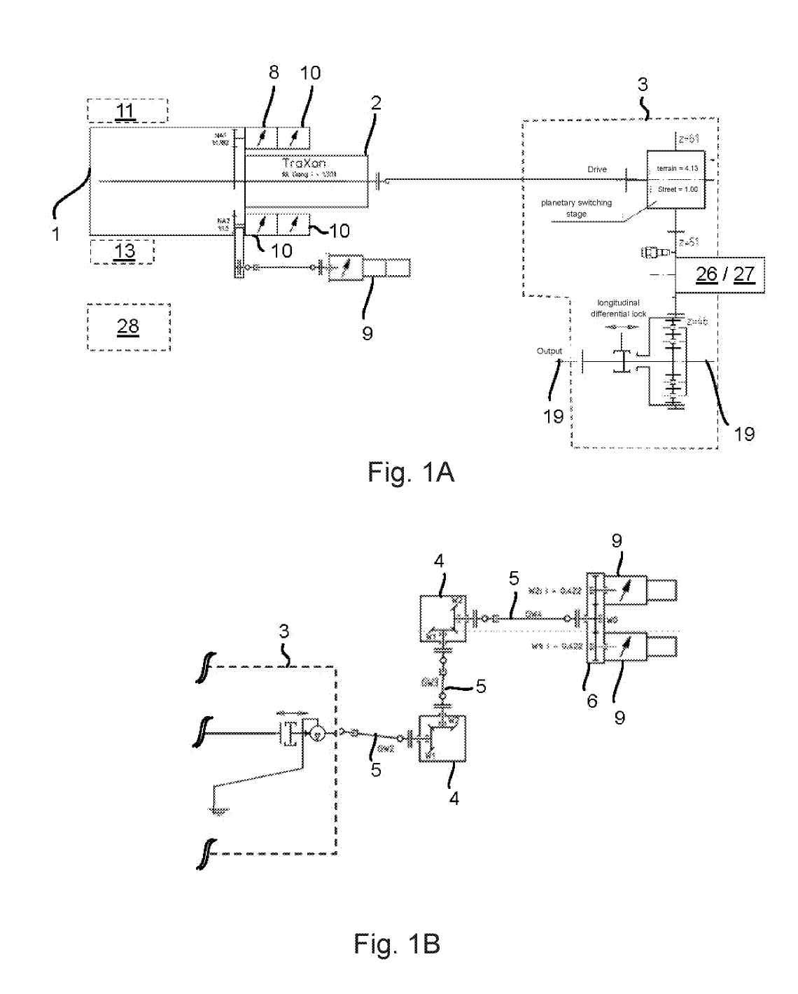

FIG. 1A shows schematically the current technical design of a steering and drive system for smaller mobile cranes with up to five axles. The internal combustion engine 1, e.g. a diesel engine, drives the vehicle axles via a shift transmission 2 and a transfer gearbox 3 and thus ensures the wheel drive 19. Hydraulic pumps, for example steering pumps 10 and the fan pump 8, are mounted directly on the internal combustion engine 1, which pumps are operated mechanically via the internal combustion engine. The compressed-air compressor 11 and the air-conditioning compressor 13 are likewise driven directly via the diesel engine.

For the hydraulic supply of the crane functions, there are in addition crane pumps 9, which are likewise connected via a power take-off by the internal combustion engine 1. These crane pumps 9 can be disengaged from the drivetrain during travel via a clutch.

In order to ensure a redundant steering function, for example when the engine is at standstill or in emergency situations, wheel-driven steering pumps 26 and a wheel-driven centering pump 27 are additionally installed, which are driven mechanically by the wheel drive 19. This design represents the current standard in smaller mobile working machines and is characterized by the fact that the hydraulic consumers are driven mechanically directly by the internal combustion engine and are thus permanently carried along, which leads to increased energy consumption for example at standstill and at low travel speeds.

FIG. 1B shows the components additionally necessary relative to FIG. 1A for a steering and drive system for larger mobile cranes with at least five axles, in which, in contrast to FIG. 1A, the crane pumps are driven not via a direct power take-off, but via a mechanical connection by means of cardan shaft 5, angle gearbox 4 and pump distributor gearbox 6 from the internal combustion engine 1. As a result, the crane pumps 9 are not located in the undercarriage, but are in the superstructure. This arrangement makes it possible to provide higher hydraulic powers for more extensive crane functions, as are required in larger mobile cranes. All other hydraulic pumps and auxiliary units such as steering pumps 10, fan pump 8, air-conditioning compressor 13 and compressed-air compressor 11 remain at their place of use.

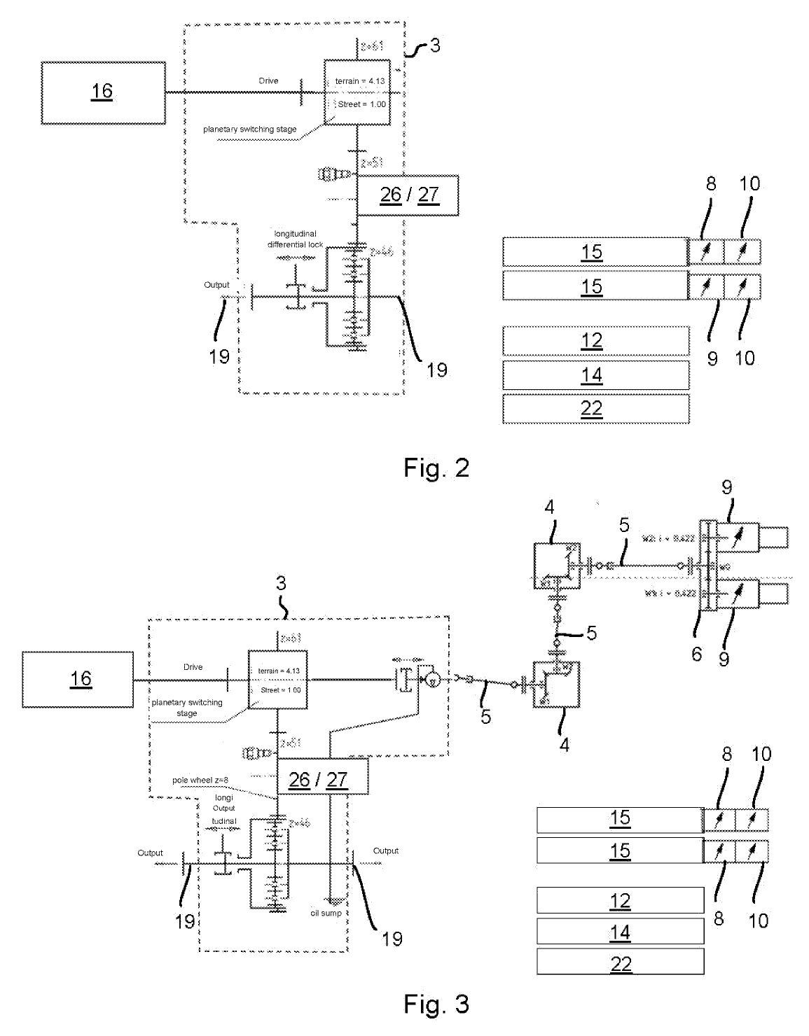

FIG. 2 shows the electrified steering and drive system according to the disclosure for smaller mobile cranes up to five axles. In contrast to the conventional drive, the supply of the hydraulic consumers such as steering pumps 10, fan pump 8 and crane pumps 9 takes place here via special high-voltage pump electric motors 15 (= HV pump electric motors), which operate independently of the internal combustion engine 1. These electric motors 15 are supplied via an HV intermediate circuit 25. As a result, individual pumps can be switched on or off according to need, whereby unnecessary energy consumption is avoided in different operating situations.

In addition, wheel-driven steering pumps 26 as well as a wheel-driven centering pump 27 are provided in order to continue to ensure steering capability in the event of a failure of the electrical systems.

The travel drive 16 can be provided with the aid of an internal combustion engine and/or an electric motor and, just like the HV pump electric motors 15 with their attached hydraulic pumps 8, 10, can be arranged in the undercarriage of a mobile working machine.

Further, the air-conditioning compressor 13 conventionally installed on the internal combustion engine 1 can be replaced by an HV air-conditioning compressor 14, so that cooling of the driver’s cab is also possible when the internal combustion engine is at standstill. Heating of the driver’s cab can be implemented via an HV heating element. A compressed-air compressor 12 can likewise be operated by means of a high voltage.

FIG. 3 describes the electrified steering and drive system specifically for larger mobile cranes with at least five axles. Here too, the supply of the auxiliary consumers such as steering pumps 10 and fan pump 8 takes place electrically by HV pump electric motors 15. In this case, however, the crane pumps 9 continue to be supplied mechanically from the internal combustion engine 1 via a cardan shaft 5, an angle gearbox 4 and a pump distributor gearbox 6. A particular advantage lies in the fact that the HV pump electric motors 15 in the undercarriage can be switched off completely during crane operation, whereby unnecessary energy consumption is reduced.

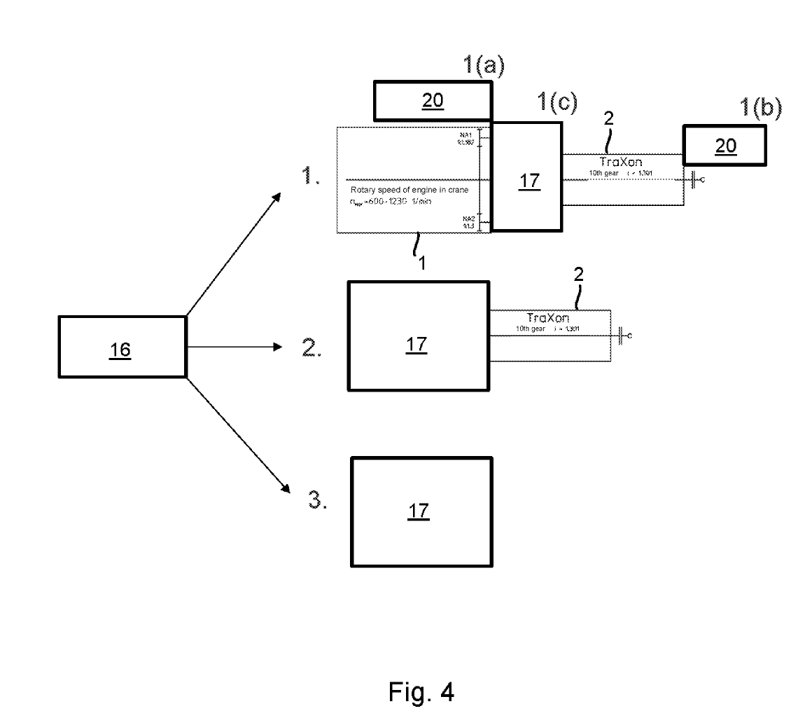

FIG. 4 illustrates three variants of the hybrid or fully electric travel drive. Variant 1 shows the hybrid drive, which combines an internal combustion engine 1 with an HV electric motor 17. In this case, there are three possibilities of providing electrical energy: in variant 1a, an HV generator 20 is attached directly to the internal combustion engine, variant 1b uses a travel-speed-dependent generator after the shift transmission 2, and variant 1c uses the HV travel motor 17 itself as a generator during braking or coasting.

Variant 2 shows a purely electric drive which, however, still uses a shift transmission, while variant 3 shows the fully electric drive without a shift transmission, in which the HV electric motor 17 acts directly on the axle or wheels 19, which considerably simplifies the construction and enables a reversal of direction without a mechanical transmission.

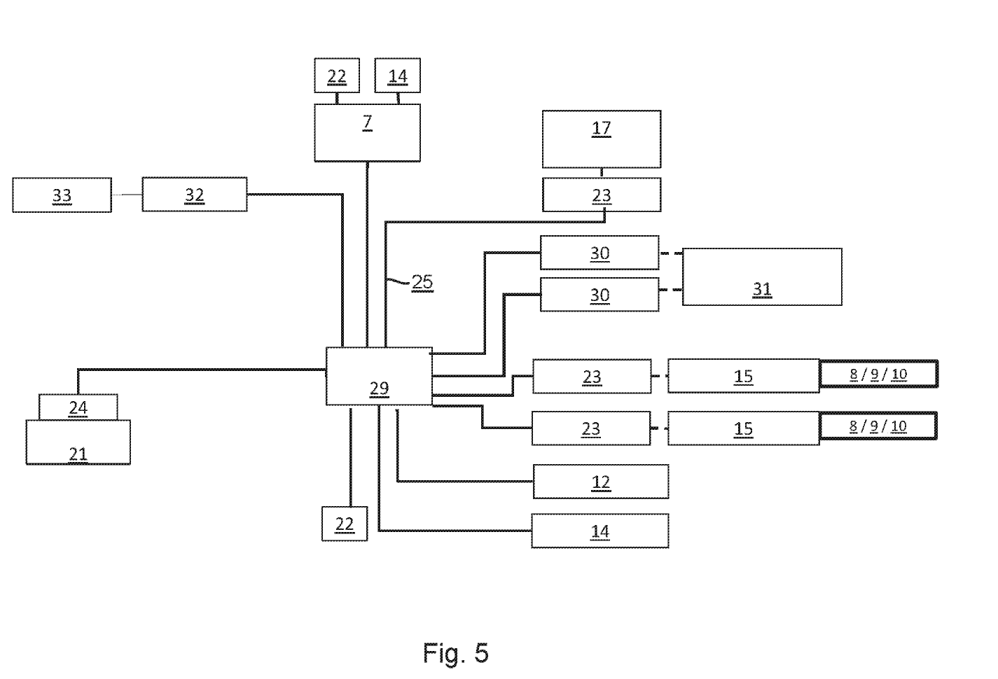

FIG. 5 shows the electrical high-voltage system and its components. Here, HV pump electric motors 15 are supplied via an inverter 23 from a DC intermediate circuit 25, which is fed by an HV battery 21 and switched via a DC contactor 24. The electrical auxiliary units such as HV compressed-air compressor 12, HV air-conditioning compressor 14 and HV heating 22 are likewise connected directly to this intermediate circuit 25 and can be operated independently of the internal combustion engine 1. Optionally, in hybrid operation an HV generator 20 is additionally available, which charges the HV battery 21 during travel. This concept permits a complete electrical decoupling of the consumers from the internal combustion engine 1 and thus low-emission and energy-efficient operation.

Reference numeral 31 denotes an external power supply, with the aid of which the battery 21 can be charged via a battery charger 30. Further, it is also possible to connect the on-board electrical system 33 to the intermediate circuit 25 via a DC/DC converter 32 and thus to supply it with energy. Reference numeral 7 describes a slip-ring transfer unit which allows the intermediate circuit 25 to be provided between the superstructure and the undercarriage of a mobile working machine.

In the illustration, the intermediate circuit 25 is shown with thick lines, said intermediate circuit carrying voltage in a high-voltage range. The on-board electrical system is operated at a voltage of typically 24 V or 48 V, so that a thin line is used here for the illustration. Dashed lines indicate an alternating voltage, i.e. for example between the inverter 23 and the HV electric motor 17, to the battery charger 30 or to the respective HV pump electric motors 15.

### LIST OF REFERENCE NUMERALS

1 Internal combustion engine
2 Shift transmission
3 Transfer gearbox
4 Angle gearbox
5 Cardan shaft
6 Pump distributor gearbox
7 Slip-ring transfer unit
8 Fan pump
9 Crane pumps
10 Steering pumps
11 Compressed-air compressor
12 HV compressed-air compressor
13 Air-conditioning compressor
14 HV air-conditioning compressor
15 HV pump electric motor
16 Travel drive
17 HV electric motor / electric travel drive
19 Wheel drive
20 HV generator
21 HV battery
22 HV heating
23 Inverter
24 DC contactor
25 DC intermediate circuit
26 Wheel-driven steering pumps
27 Wheel-driven centering pump
28 Fuel-operated auxiliary heater
29 HV distributor box
30 Battery charger
31 External power supply
32 DC-DC converter
33 On-board electrical system

1. A steering arrangement for a mobile working machine, comprising:
a steering cylinder for moving a steering rod in order to vary a steering angle of a wheel of the mobile working machine,
a hydraulic steering pump for supplying a fluid to the steering cylinder,
a drive of the hydraulic steering pump, and
an energy storage device for storing electrical energy,
wherein the drive of the hydraulic steering pump is an electric motor that can be driven with energy from the energy storage device.

2. The steering arrangement according to claim 1, further comprising a direct-current intermediate circuit via which the electric motor for driving the hydraulic steering pump and the energy storage device are connected to one another.

3. The steering arrangement according to claim 1, further comprising a wheel-driven pump which is designed to supply fluid to the steering cylinder as a function of a rotation of a wheel of the mobile working machine.

4. The steering arrangement according to claim 3, wherein the steering arrangement is designed, upon an exceeding of a predetermined volumetric-flow threshold value of the fluid of the wheel-driven pump, to stop the electric motor for driving the hydraulic steering pump in order to save energy.

5. The steering arrangement according to claim 1, further comprising a generator unit which serves to supply the energy storage device with energy.

6. The steering arrangement according to claim 5, further comprising a direct-current intermediate circuit via which the electric motor for driving the hydraulic steering pump and the energy storage device are connected to one another, wherein the generator unit is connected to the direct-current intermediate circuit and is accordingly also designed to supply electrical energy to the electric motor for driving the hydraulic steering pump.

7. The steering arrangement according to claim 1, wherein:
several hydraulic steering pumps are provided, the respective drive of which takes place via the electric motor, and/or
the electric motor is a liquid-cooled electric motor.

8. A mobile working machine, comprising:
the steering arrangement according to claim 1, and
a travel drive for driving at least one wheel of the mobile working machine,
wherein the travel drive comprises an electric motor and/or an internal combustion engine.

9. The mobile working machine according to claim 8, wherein:
the mobile working machine has an undercarriage and a superstructure arranged rotatably relative thereto, and
the hydraulic steering pump and the electric motor for driving the hydraulic steering pump are arranged in the undercarriage.

10. The mobile working machine according to claim 8, further comprising:
an electric fan for cooling the fluid, cooling water and/or charge air,
an electric compressed-air compressor for providing compressed air in order to actuate a brake of the mobile working machine,
an electric air-conditioning compressor for driving an air-conditioning unit in order to air-condition a driver’s cab of the mobile working machine,
an electric heating element for heating the driver’s cab of the mobile working machine, and/or
an electric crane pump for driving crane functions.

11. The mobile working machine according to claim 8, the steering arrangement further comprising a generator unit which serves to supply the energy storage device with energy, wherein, when the travel drive comprises an internal combustion engine, the generator unit is installed on the internal combustion engine in order to generate directly, with the aid of the internal combustion engine, the energy required for operating the electric motor.

12. The mobile working machine according to claim 8, the steering arrangement further comprising a generator unit which serves to supply the energy storage device with energy, wherein, when the travel drive comprises an internal combustion engine, the generator is arranged on a shaft which is located after a shift transmission, that is to say rotates as a function of travel speed, in order to charge the energy storage device only during travel.

13. The mobile working machine according to claim 8, wherein the travel drive is not a central travel drive, but an axle-related or wheel-related travel drive, which drives at least one axle or at least one wheel of the mobile working machine.

14. The mobile working machine according to claim 10, wherein the hydraulic steering pump, the fan, the compressed-air compressor, the air-conditioning compressor, the heating element and/or the crane pump is/are decoupled from a drivetrain of the mobile working machine.

15. The mobile working machine according to claim 10, wherein the hydraulic steering pump, the fan, the compressed-air compressor, the air-conditioning compressor, the heating element and/or the crane pump is/are configured as high-voltage component(s).

16. The steering arrangement according to claim 1, wherein the mobile working machine is a crane.

17. The steering arrangement according to claim 2, wherein an inverter is arranged between the electric motor and the direct-current intermediate circuit in order to convert the direct current into an alternating current for the electric motor.

18. The steering arrangement according to claim 4, wherein the volumetric-flow threshold value is directly proportional to a travel speed of the mobile working machine or is a defined travel speed of the mobile working machine.

19. The mobile working machine according to claim 8, wherein the mobile working machine is a crane.

20. The mobile working machine according to claim 10, wherein the electric fan, the electric compressed-air compressor, the electric air-conditioning compressor, the electric heating element and/or the electric crane pump are connected to the direct-current intermediate circuit in order to draw their energy therefrom.
